(19) United States
(12) Patent Application Publication
(10) Pub. No.: US 2024/0252952 A1
(43) Pub. Date: Aug. 1, 2024

(54) Natural Deep Eutectic Extractions

(71) Applicant: Bioeutectics Corporation, Wilmington, DE (US)

(72) Inventors: Tomás Silicaro, Nordelta (AR); Sergio David Pasini Cabello, Ayacucho (AR); Maria Romina Canales, Junin mendoza (AR)

(73) Assignee: Bioeutectics Corporation, Wilmington, DE (US)

(21) Appl. No.: 18/427,859

(22) Filed: Jan. 31, 2024

Related U.S. Application Data
(60) Provisional application No. 63/442,123, filed on Jan. 31, 2023.

(51) Int. Cl. B01D 11/02; C02F 1/26; C02F 101/30

(52) U.S. Cl. CPC B01D 11/0288; C02F 1/26; C02F 2101/308

(57) ABSTRACT

NADES (Natural Deep Eutectic Solvents) isolated from natural sources for extraction purposes are tied to a plurality of potential uses. The extraction of natural products from various sources by these NADES show enhanced extraction abilities. The extracted natural products using the NADES of the present invention have uses as food additives, dyes/colorings, medicines, and other potential uses. Chlorophyll(s), lycopene(s) cannabinoid(s), and red dyes from a fungus are natural products which have been isolated by the NADES of the present invention. They have potential uses in food additives, as dyes, in medicines, and in other uses.

### CROSS-REFERENCE TO RELATED APPLICATIONS

The present application claims priority under 35 USC 119(e) to U.S. Provisional Application No. 63/442,123 filed Jan. 31, 2023, the entire contents of which is incorporated by reference.

### FIELD OF THE INVENTION

The present invention relates to the use of NADES (Natural Deep Eutectic Solvents) from natural sources for extraction purposes that are tied to a plurality of potential uses. The extraction of natural products from various sources shows enhanced extraction abilities by using the eutectic solvents of the present invention. The extracted natural products using the NADES of the present invention have uses as food additives, dyes/colorings, medicines, and other potential uses.

### BACKGROUND OF THE INVENTION

Deep eutectic solvents or DESs are solutions of Lewis or Brønsted acids and bases which form an eutectic mixture. Deep eutectic solvents are highly tunable by varying the structure of the components or by varying the relative ratios of various components in the mixture. Because these are complicated systems that have widely varying properties, they have a wide variety of potential applications, including their use in catalysis, separation techniques, and electrochemical processes. The parent components of deep eutectic solvents tend to engage in complex hydrogen bonding networks, which means that the mixture tends to have significant freezing point depressions relative to the parent compounds/components in the mixture. Sometimes the individual components in the mixture may be solids at room temperature and atmospheric pressure, but when they are mixed together at room temperature and atmospheric pressure, the mixture may be a liquid that has a severely depressed freezing point (e.g., 10° C.).

NADES are eutectic mixtures formed by a combination of natural compounds with a specific molar ratio. NADES materials are promising for a plurality of applications as inexpensive solvents that demonstrate a host of tweakable (tunable) physicochemical properties. Complex hydrogen bonding is postulated as one of the root causes of their melting point depressions and is an attribute that some contend accounts for their physicochemical properties. By adjusting relative amounts of the various components one is able to attain properties that may not be attained by other relative amount compositions even if they contain the same components. However, as NADES related systems are being newly discovered and explored, one must not only understand these hydrogen bonded NADES networks, but it is also imperative to discover their properties by studying the systems as dynamic entities using both simulations and experiments.

The term “eutectic” was first coined in 1884 by British chemist and physicist Frederick Guthrie. The first generation of eutectic solvents were based on mixtures of quaternary ammonium salts with hydrogen bond donors such as amines and/or carboxylic acids. NADES are biologically based deep eutectic solvents which are composed of two or more compounds that are generally plant based primary metabolites, i.e., organic acids, sugars, alcohols, amines and amino acids. Water may also be present as part of the solvent.

Much of the study of eutectic solvents since Frederick Guthrie coined the term “eutectic” has involved solvent mixtures wherein at least one of the components is a metal based solvent. However, the discharge of metals from these solvent systems has demonstrated many of the drawbacks associated with metal leaching, and its associated health, environmental, and safety related issues. Accordingly, there has been some recent interest in non-metal containing eutectic systems.

U.S. patent Ser. No. 10/865,334 relates to a process for extracting materials from biological material, which process is characterized in that the naturally occurring biological material is treated with an extract consisting of a deep eutectic solvent of natural origin or an ionic liquid of natural origin to produce a biological extract of natural origin dissolved in the solvent or ionic liquid.

IN202041012054A relates to a synergistic formulation that can be adopted as a medium for easy extraction of phytochemicals from natural sources—biomass and herbs. The medium is adopted in the preparation of feed supplements for livestock, enriched in nutritional value.

U.S. Ser. No. 10/981,084B2 relates to the use of coconut water as an extraction solvent, to extraction methods using coconut water and extracts obtained by extraction with coconut water. The discussion of deep eutectic solvents appears in the background of the invention.

WO2022101490A1 relates to the development of Natural Deep Eutectic Solvents (NADES) using natural products, like sugars, organic bases and organic acids, as starting compounds. These solvents can be used for the extraction of bioactive compounds from natural sources, such as cork; agricultural wastes, including grape seed and peels; tomato; olive oil; and plants (teas, eucalyptus, lavender, or others), and from fish skin and bones. The extractives may then be further formulated with active topical cosmetic components to prepare cosmetic compositions. WO2022101490A1 focuses on the application of NADES for the extraction of chemical compounds from natural sources. The extraction methods applied use the “enfleurage” method, which is an ultrasound-assisted extraction and sealed system extraction. The natural extracts isolated and obtained can then be applied directly in cosmetic formulations without further purification.

EP3971230A1 relates to a deep eutectic solvent (DES) comprising at least one carboxylic acid which comprises at least two carboxylic acid functional groups with a number of carbon atoms that range from 4 to 10; at least one alcohol which comprises at least two alcohol functional groups, with the alcohols having 2 to 12 carbon atoms, polyethylene glycol and polypropylene glycol; and water in an amount of from 10 to 50 wt. % of the total weight of the deep eutectic solvent. This reference describes the use of a DES as a solvent system for solubilizing lignin from a lignin containing material, or the use of the DES for preparing a lignin-prepolymer which can be subsequently used in applications such as for producing films, coatings, insulating foams, adhesives, binders, composites or for fibre sizing or for radical curing.

EP3693418A1 relates to a solvent composition, in particular a solvent composition with components of natural, non-petrochemical origin. It relates to a solvent composition based on compounds of vegetable origin deriving from the fermentation of carbohydrates, wherein those carbohydrates are glucose, fructose, sucrose, starches, cellulose and mixtures thereof. Although this reference discloses solvent mixtures, it does not appear to relate to deep eutectic solvents.

EP4011353 relates to eutectic solvents formed from the mixture of ascorbic acid (vitamin C) in combination with Betaine and a third component selected from the group comprising Water, Ethanol, Glycerol, Diols and/or Triols with 6 or less than 6 C-atoms, especially 1,3-Propanediol, Butylene Glycol and Hexanediol. The eutectic solvents allow for incorporation of these active ingredients into cosmetic compositions.

Although the above references do tangentially relate to eutectic mixtures and some relate to the isolation/extraction of mixtures, none or the references disclose or suggest the combination of extractive procedures and isolation protocols of NADES that are disclosed herein. By using different components or different ratios of these eutectic solvent mixtures and/or additives that differ from the prior art, one is able to attain these surprisingly superior properties.

### BRIEF SUMMARY OF THE INVENTION

The present invention relates to using NADES for extraction processes. In an embodiment, the system/method includes using different ratios of the components to provide new and/or unexpectedly superior properties relative to eutectic mixtures of the prior art. In a variation, natural deep eutectic solvents (NADESs) have emerged and attracted increasing interest in the last few years. NADESs have been regarded as a type of interesting alternative to ionic liquids (ILs) owing to their ease of preparation, high biodegradability, low toxicity and high tunability. One potential use of these solvent systems is in their ability to extract polyphenols, anthocyanins, cannabinoids, methylene blue, and other molecules from other sources. Other potential uses include their use in metal recovery and the separation of metals from matrices like electronic waste, minerals, biological samples, and environmental samples such as soil and wastewater.

### BRIEF DESCRIPTION OF THE SEVERAL VIEWS OF THE DRAWING

FIG. 1 shows the UV Vis profile of pure lycopene in the region between about 300-550 nm where the primary absorption occurs.

FIG. 2 shows the various UV Vis profiles of the lycopene extracts using the various tested NADES.

FIG. 3 shows a bar graph summarizing the UV Vis profile of LuAOAEtCi, as well as its comparative recovery with hexane.

FIG. 4 shows the results of experiments that were performed wherein extraction of lycopene was tested as a function of temperature.

FIG. 5 shows the results of an experiment wherein extraction of lycopene was tested as a function of time wherein extractions were carried out with a fixed mass/solvent ratio of 10% w/w.

FIG. 6 shows the results of an experiment that was performed doing an extraction of lycopene as a function of the Tomato Extract/Solvent ratio.

FIG. 7 shows the UV Vis spectra of pure chlorophyll A and chlorophyll B. From: https://commons.wikimedia.org/wiki/File:Chlorophyll_ab_spectra-es.svg

FIG. 8 shows the UV Vis spectra of extracts of Chlorophyll using several of the NADES of the present invention and of ethanol.

FIG. 9 shows the UV Vis spectra of extracts of Chlorophyll B using several of the NADES of the present invention and of ethanol.

FIG. 10 shows photographs demonstrating the stability of Chlorophyll extracted by one of the NADES of the present invention.

FIG. 11 shows the results of dispersion of the red dye from a fungus in mix with the optimal extractive product with the left side showing a hydrophobic component and the right side showing a hydrophilic component.

FIG. 12 shows the results of dispersion of the red dye from a fungus in a mix with the optimal extractive product with the left side showing a hydrophobic component and the center tube showing a hydrophilic component and the right side showing a eutectic mixture of the present invention.

FIG. 13 shows the same tubes as FIG. 12 with water added to each tube.

### DETAILED DESCRIPTION OF THE INVENTION

The present invention relates to using NADES for extraction processes. In an embodiment, the system/method includes using different ratios of the components to provide new and/or unexpectedly superior properties relative to eutectic mixtures of the prior art. In a variation, natural deep eutectic solvents (NADESs) have emerged and attracted increasing interest in the last few years. NADESs have been regarded as a type of interesting alternative to ionic liquids (ILs) owing to their ease of preparation, high biodegradability, low toxicity and high tunability. One potential use of these solvent systems is in their ability to extract polyphenols, anthocyanins, cannabinoids, methylene blue, and other extracts from other sources. Other potential uses include their use in metal recovery and the separation of metals from matrices like electronic waste, minerals, biological samples, and environmental samples such as soil and wastewater.

In an embodiment, the NADES of the present invention can be used for the extraction of various natural products. The NADES of the present invention have been demonstrated to show superior results relative to the solvents that have traditionally been used to extract these natural products. By using the eutectic solutions of the present invention, the NADES of the present invention demonstrate better results with the extraction of lycopene, chlorophyll and cannabinoids relative to the solvents that have been traditionally used.

### EXAMPLES

Example 1: LGH, Lactic acid (20-90%), Glucose (10-40%), Water (5-15%): It has been discovered that this is a very versatile product. It can be used for the extraction of polyphenols and anthocyanins from subproducts of the food and beverages industries. This product has demonstrated enhanced extraction, and it has the ability to extract a wide range of compounds based upon synergism between its polarity and enhanced antimicrobial activity. It also demonstrates antimicrobial properties and thus, it can be used for those purposes. This product demonstrates stability under room temperature and atmospheric pressure. It demonstrates solubility in water, low molecular weight alcohols such as methanol and ethanol, acetone, and dimethyl sulfoxide. It is largely insoluble in alkyls such as hexane. Transparent odorless liquid, MP<−18° C., BP 110° C., pH 1.3, density 1.20 g/ml, viscosity 31 mPa s (20° C.), conductivity 402 μs/cm, refractive index 1.423.

Example 2: AM: Camphor (25-45%), Menthol (55-75%): Selective extraction of Lycopene from subproducts of tomato industries. This product has demonstrated outstanding selectivity and stability of Lycopene in liquid media for at least one year. This product demonstrates stability under room temperature and atmospheric pressure. It is insoluble in water, but soluble in low molecular weight alcohols such as methanol and ethanol, acetone, and dimethyl sulfoxide. It is soluble in alkyls such as hexane. Light yellow liquid with faint odor, pH 4.7, density 0.91 g/ml, viscosity 62.1 mPa s (20° C.), conductivity 0 μs/cm, refractive index 1.463.

LuAOAEtCi: Lauric acid (10-60%), Oleic acid (20-80%), triethyl citrate (10-80%%): Selective extraction of Lycopene from subproducts of tomato industries. This product is food-grade and has demonstrated outstanding selectivity of Cis-lycopene. This product demonstrates stability under room temperature and atmospheric pressure. It is insoluble in water, but soluble in low molecular weight alcohols such as methanol and ethanol, acetone, and dimethyl sulfoxide. It is soluble in alkyls such as hexane.

Example 3: TL: Lactic Acid (20-80%), Thymol (20-80%): Selective extraction (with high stability) of Chlorophyll from plant tissues. This product has demonstrated outstanding selectivity and stability of Chlorophyll in liquid media for at least one year.

Example 4: MOA: Menthol (10-70%), Oleic Acid (30-90%): This mix can be used to extract cannabinoids from Cannabis sativa. This product has demonstrated higher extraction yields for THC/THCA (tetrahydrocannabinol/tetrahydrocannabinolic acid) compared with ethanol. Also this product demonstrated high selectivity for THC/THCA.

Example 5: MAcA: Menthol (20-90%), Acetic Acid (10-80%): This product is the perfect complement for MOA_08. Extraction of cannabinoids from Cannabis sativa. This product has demonstrated higher extraction yields for CBGA (Cannabigerolic acid) compared with ethanol. Also a product that is eucalyptol/geraniol has demonstrated high selectivity for CBG/CBGA.

Example 6: TOA: Thymol (10-45%), oleic acid (50-90%): This can be used in the extraction of methylene blue from contaminated water. This product has demonstrated higher yields in dye extraction and an outstanding preconcentration factor, which is a quantitative measure of the NADES ability to extract the extracted material.

Example 7: EucGe: Eucalyptol (30-70%), Geraniol (30-70%): This product can be used in the extraction of cannabinoids from Cannabis sativa.

### Lycopene Extractions

Laboratory tests were conducted using a natural tomato as a sample, which was previously processed with a kitchen blender until obtaining a homogeneous mixture, which was kept refrigerated until the end of the tests.

Several tests were performed ascertaining the ability of the various NADES disclosed herein to extract lycopene or cis-lycopene from tomato extract:

The following table 1 gives the qualitative results of the tested NADES.

TABLE 1
It should be noted that different numbers mean different
compositions of the same solvent system.

| | Extract | |
|---|---|---|
| NADES | Color | Observations |
| CGlH_05 | NO | |
| CSH_03 | NO | Small parts of the pulp are scattered |
| | | in the NADES. |
| CSH_05 | NO | The pulp was scattered on the bottom, |
| | | dispersing in the NADES. |
| CSH_11 | NO | |
| CSH_13 | NO | |
| LGl_04 | NO | |
| LGXi_13 | NO | |
| XXiH_05 | NO | |
| XXiH_07 | NO | |
| UGIH_04 | YES | A very faint and pale pink color is observed, |
| | | translucent. Which is hard to appreciate. |
| UGIH_13 | YES | It is a very pale pink color, almost |
| | | imperceptible. |
| AT_01 | YES | An intense orange color was extracted. |
| | | The pulp was white. |
| AT_07 | YES | A light orange color was extracted. |
| | | The pulp was red. |
| AT_13 | YES | An intense orange color was extracted. |
| | | The pulp was orange. |
| UL_01 | NO | |
| LGH | NO | |
| ML_06 | YES | Extracted a translucent pale-yellow color. |
| AM_03 | YES | An opaque dark deep orange color was |
| | | extracted. |
| AM_09 | YES | An opaque dark deep orange color was |
| | | extracted. |
| TL_01 | YES | A pale translucent, greenish-yellow color is |
| | | extracted. |
| TL_05 | YES | A pale translucent, greenish-yellow color is |
| | | extracted. |
| LuAOAEtCi-01 | YES | An intense dark orange color was extracted. |
| | | The pulp was light orange. |

CGlH: Citric Acid (25-90%), Glycerol (5-70%), Water (1-25%)
CSH: citric acid (15-50%), sorbitol (15-60%), and water (10-60%)
LGl: Lactic acid (5-40%), Glycerol (10-45%)
LGXi: Lactic acid (10-85%), Glucose (10-75%), Xylose (5-85%)
XXiH: Xylitol (15-60%), Xylose (15-80%), Water (2-45%)
UGIH: Urea (10-55%), Glycerol (15-80%), Water (0-35%)
AT: Camphor (30-60%), Thymol (40-70%)
UL: Urea (20-40%), Lactic Acid (60-80%)
ML: Menthol (25-65%), Lactic Acid (35-75%)

Based on the qualitative assays for the extraction of lycopene from tomato extract, the extractions that showed promise (those that showed some color) were subjected to an exhaustive assay using their UV-Vis profile to identify and compare different extractions. The web site https://acuariodearrecife.com/parametros/iluminacion/definicion-de-par-pur-ppf-y-grados-kelvin-en-iluminacion/#pgcSgb-sl-1_4741 has evaluated regions where maximal absorption of various pure proteins from plants can be found. This web site shows the UV Vis profiles of lycopene, chlorophyll a, chlorophyll b, □-carotane, lutein, and zeaxanthin on the same spectrogram and allows one to find absorbance maximal peaks for the various proteins so that an absorbance profile of one protein does not interfere with the other proteins. For example, by measuring absorbance at about 510-520 nm, one may be able to quantitatively identify the amount of lycopene (using Beer's Law) using a shoulder of the maximal absorbance, thereby allowing one to ascertain the relative amount of lycopene in a given sample without spectral absorbance interference from the other enumerated plant proteins.

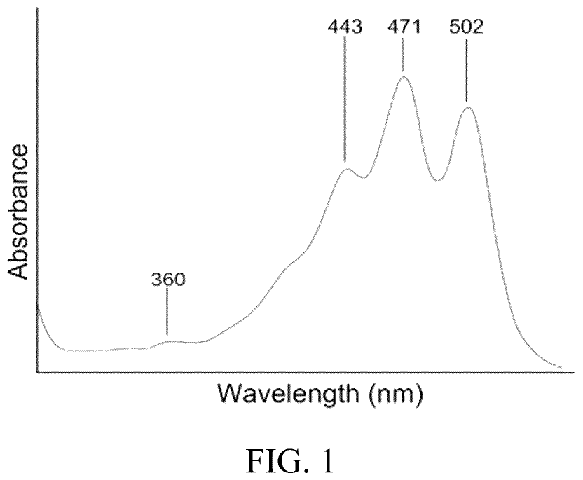

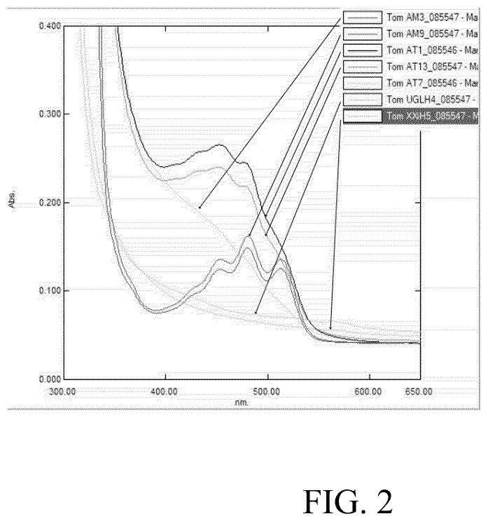

FIG. 1 shows the UV Vis profile of pure lycopene in the region between about 300-550 nm where the primary absorption occurs. This was used as a type of standard curve on which to qualitatively analyze the abilities of the various NADES to extract lycopene (as shown in FIG. 2). FIG. 2 shows the various UV Vis profiles of the extracts using the various tested NADES. AM, AT, UGIH and XXiH were tested. The results shown in FIG. 2 demonstrate that several of the NADES did not extract lycopene to any great extent (UGIH, XXiH) while others extracted lycopene together with other analytes (AT). However, AM gave not only good extraction abilities but also a selective extraction of lycopene. Accordingly, AM was chosen as a principal NADES extractor because of the good and selective extraction of lycopene.

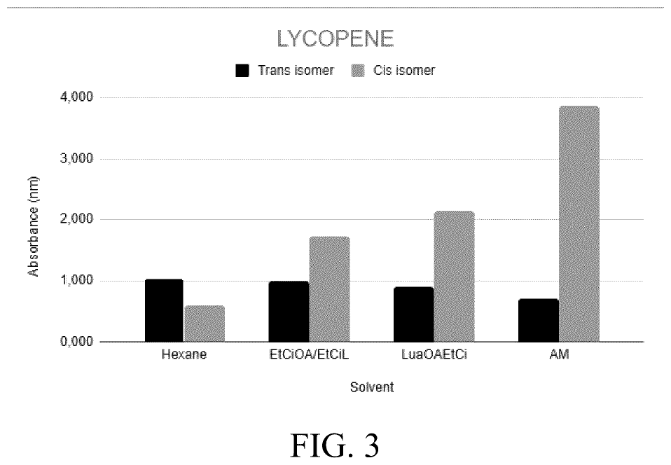

FIG. 3 shows the UV Vis profile of LuAOAEtCi, as well as the comparative recovery with hexane. The results demonstrate that this product selectively extracts the most bioavailable lycopene isomer, cis-lycopene. It is important to point out that hexane extracts mostly the trans isomer.

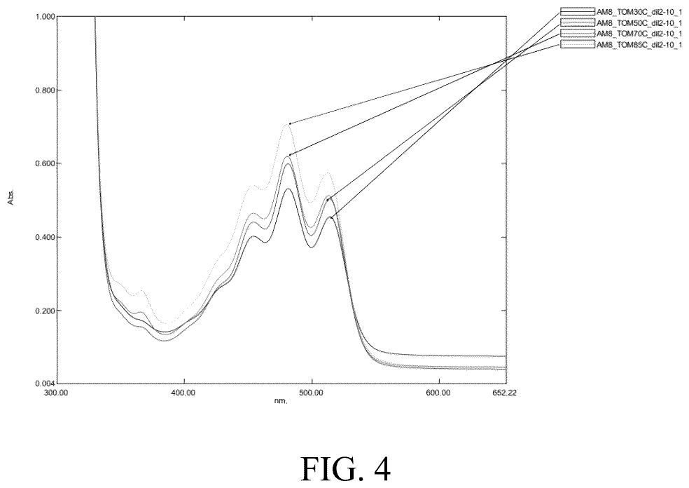

Subsequently, experiments were performed wherein extraction was tested as a function of temperature. FIG. 4 shows the results of these experiments. The extractions were carried out with a fixed mass/solvent ratio of 10% w/w. Extractions were carried out for 20 min with temperature stabilization provided by a water bath at various temperatures, the extractions being shaken every 10 min for 1 min. The extractions were carried out at 30° C., 50° C., 70° C., and 85° C.

As the temperature increased, the amount of lycopene extracted increased. 50° C. was chosen as the optimal temperature to carry out the extraction, based on the degree of improvement with respect to the energy input.

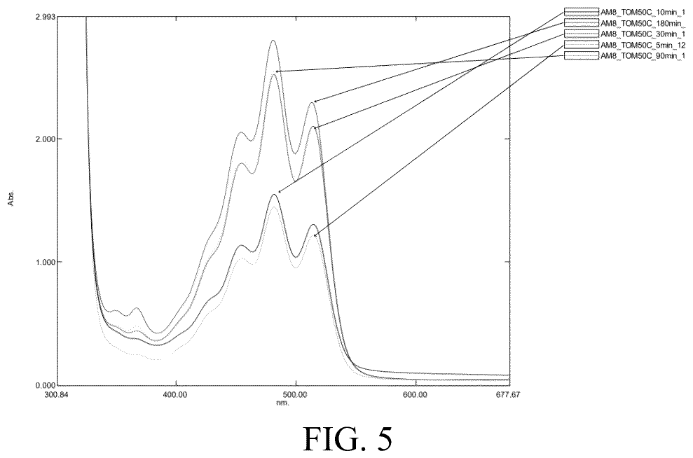

Extraction was also tested as a function of time. Extractions were carried out with a fixed mass/solvent ratio of 10% w/w. The extractions were carried out at 50° C. in a water bath at various times, shaking every 10 min for 1 minute. Extraction times were 5, 10, 30, 90, and 180 minutes. Although in all cases an increase in the extraction time resulted in an improvement, 30 minutes was selected as the optimal extraction time since after this time the increase diminishes considerably. FIG. 5 shows the results of this experiment.

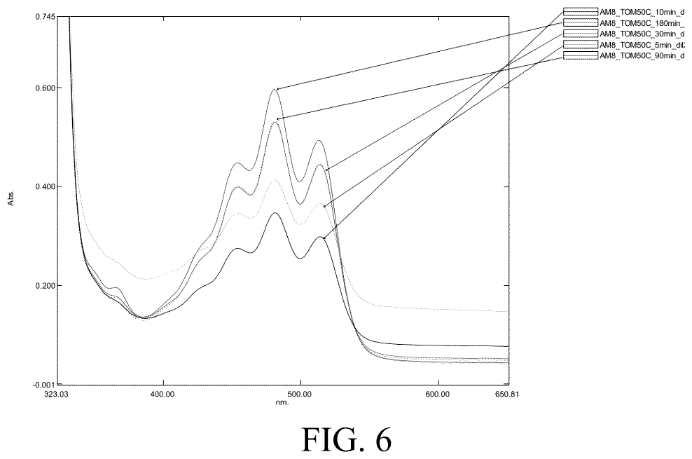

An experiment was performed doing an extraction as a function of the Tomato Extract/Solvent ratio. Extractions were performed at 50° C. in a water bath for 30 minutes with vortexing every 10 minutes for 1 minute. Five different sample/solvent ratios were evaluated: 1% w/w, 2% w/w, 10% w/w, 30% w/w, and 50% w/w. The results of this experiment is shown in FIG. 6.

In no case did the NADES reach its maximal degree of saturation. Even the sample that contained 50 percent tomato mass/solvent, so the mass ratio with which the extraction is carried out will be clearly conditioned by the separation method of the solvent with the sample, filtered, centrifuged, and so on.

### 4. Results

Based on the observed results, an appropriate solvent was selected that allows the selective extraction of lycopene from tomato pulp. An extraction method was also optimized considering characteristics such as sample/solvent mass ratio, temperature, and extraction time. The results showed optimal values as indicated below:
a. Sample/solvent mass ratio: 10% p/p (variable from 1-50% depending on the separation method)
b. Temperature: 50° C.
c. Extraction time: 30 minutes

Solvent selected: AM_09

### Difference Between Tomato Extract and Lycopene Extracted in AM

Subsequently, the differences were ascertained between the lycopene extracted using AM and extraction using comparative solvent extractions of the prior art.

### Traditional Solvent Extraction to Compare Extractive Power:

A traditional extraction will be performed to compare the extractive abilities of the presently tested NADES versus those of the prior art. For example, the present NADES will be tested against more traditional solvents such as using ethyl acetate and hexane. Extraction will be performed with a solvent and soxhlet extractor. Initially, experiments will be performed to see if extraction is possible and if it is found to be possible, to see if it can be done to an extent that makes the extraction worthwhile.

Initially, a determination of extract concentration will be desired to be measured qualitatively. A standard curve will have to be developed, which will allow a comparison to be done using analytical methods to ascertain extract concentrations.

Stability studies will also be performed to measure and record the variation of the UV signal of lycopene extracts in different conditions, such as at room temperature in both light and darkness, at different temperatures such as the temperature that is typically present in a refrigerator (˜1° C. to 4° C.), and/or freezer (˜−15° C. to −20° C.).

### Results of Cannabinoid Extracts

The extracts were analyzed by HPLC. HPLC analysis of the hemp extracts was carried out using an Agilent Infinity 1100 HPLC System, and an Agilent 1100 series photodiode-array detector (DAD) for detection and recording using UV/Vis at a wavelength of 220 nm. The cannabinoids chromatographic separations were achieved using a Kinetex C-18 column (100 mm×4.6 mm ID and 2.6-μm particle size, 100 Å pore size). The method used for the HPLC analysis was adapted from the Cannabinoids on Raptor ARC-18 Restek LC_GN0553 methodology.

As mobile phase A: 0.1% Formic acid in water and B: 0.1% Formic acid in acetonitrile were used, the solvent flow was kept constant at 1.5 ml/min with the following gradient profile: 0.00-4.00 min 25% of solution A, 75% of solution B, 0.00-4.01 min 0% of solution A, 100% B of solution and 4.01-7.00 min 25% of solution A, 75% of solution B. The column oven was kept at 50° C. during the run, and the injection volume was of 5 μL.

The following table 2 reveals the results of the experiments.

TABLE 2
All units are in mg/mL.

| | | solvent | NADES tested | | |
|---|---|---|---|---|---|
| Cannabanoid extracted | | ethanol | EucGe | MOA | MAcA |
| Cannabidivarinic acid | CBDVA | | | | |
| Cannabidivarin | CBDV | | | | |
| Cannabidiolic acid | CBDA | | | | 0.03 |
| Cannabigerolic acid | CBGA | | 0.48 | | 0.44 |
| Cannabigerol | CBG | | 0.24 | | 0.03 |
| Cannabidiol | CBD | | | | |
| Tetrahidrocannabivarin | THCV | | | | |
| Tetrahidrocannabivarinic | THCVA | 0.03 | 0.19 | | 0.03 |
| acid | | | | | |
| Cannabinol | CBN | | | | |
| Δ-9-Tetrahidrocannabinol | Δ-9-THC | 0.46 | 0.32 | 0.34 | 0.34 |
| Δ-8-Tetrahidrocannabinol | Δ-8-THC | | | | |
| Cannabichromene | CBC | | | | |
| Tetrahidrocannabinolic | THCA | 3.37 | 3.54 | 5.20 | 3.80 |
| acid | | | | | |

Conclusions from Cannabinoid Extractions

Several conclusions can be ascertained by the above table 2. EucGe is able to extract both CBG and CBGA whereas ethanol extract used as the comparative reference didn't have CBG or CBGA detectable concentrations. MOA gives a higher extraction yield than ethanol extracts for A-9-THC and THCA. The preliminary results show that MACA presents selectivity for CBD extraction.

### Chlorophylls Extractions

The objective is to determine the extraction/dissolution capacity of chlorophylls in the NADES of the present invention, as well as chlorophyll's stability and coloring power in these various solvents. Accordingly, in one embodiment, the goal is to use the best NADES that show optimal extractive abilities to supply it as a solvent to the dye industry or to any other industry that may use chlorophyll.

There are a plurality of different Chlorophylls, which tend to be green in color. Chlorophylls occur naturally in the cells of plants and are the molecules that are principally responsible for photosynthesis. Chlorophylls are fairly unstable dye, and they tend to fade easily. It is not easy to obtain chlorophylls in a pure form. Therefore, most commercially available chlorophyll samples usually contain other plant material impurities. Chlorophylls are usually obtained from nettles, spinach and grass with the chlorophylls typically being extracted using one or more of acetone, ethanol, light petroleum, methylethylketone and dichloromethane. Lutein, (an antioxidant from the group of compounds that are in the carotenoid compound group) may be extracted at the same time.

The chlorophylls can be used as colorants (e.g., as Pigments or dyes that are added in order to change or enhance the color). Chlorophyll(s) is/are green pigment(s) found in algae and plants. Chlorophyll is vital for photosynthesis, which allows plants to absorb energy from light. As a food additive (E140, the International Numbering System number assigned to chlorophylls for food additives), it is usually extracted from nettles, grass and alfalfa and used in pasta, absinthe, cheeses, preserved vegetables, jams, jellies and marmalade. Chlorophylls can also be used for dyeing waxes and oils, and can be used in medicines and cosmetics. They are approved for use as food coloring in the EU. It is also used as a synthetic coloring agent in food and drink products.

The two forms E140(i) and E140(ii) are referred to as chlorophylls (the oil soluble derivative) and chlorophyllins (the water soluble derivative), respectively. E140(i) and E140(ii) give a dark green color and occur naturally (for photosynthesis) in all plants. E140(i) and E140(ii) can be used in cosmetics and medicine as well as in food products. When used for commercial purposes, the chlorophylls and chlorophyllins tend to be extracted from plants such as alfalfa, grass and nettles. These colorings may be soluble in water, though their intensity may fade with time.

There are no known adverse effects of chlorophylls and chlorophyllins. Examples of food and drink products that sometimes include E140(i) and E140(ii) include: sweets, ice cream, soups, chewing gum, fats and oils, and/or preserved fruits and vegetables.

### Laboratory Tests

The following sample was prepared. Natural spinach was used as a sample, and the spinach was processed with a kitchen blender until obtaining a homogeneous mixture, which was kept refrigerated until the end of the tests.

Extraction of Chlorophylls from Spinach Extract with Several NADES

Consistent with the testing performed for lycopene, the following methodology/characteristics was/were used to extract chlorophyll from spinach extract:
a. Sample/solvent mass ratio: 10% p/p
b. Temperature: 50° C.
c. Extraction time: 20 minutes (1 minute vortex every 5 minutes)
   Extraction with Several NADES

Several NADES were tested as chlorophyll(s) extractors from spinach extract. The following table 3 summarizes the qualitative results obtained.

TABLE 3

| | Extracts | |
|---|---|---|
| NADES | color? | Observations |
| CGlH_05 | yes | Green color was observed, but the day after the |
| | | extraction the color turned military green, with |
| | | brown tones. |
| CSH_03 | yes | A bright green color is observed, but a few minutes |
| | | after extracting it, it begins to take on a military |
| | | green color, with brown tones. |
| CSH_05 | yes | A bright green color is observed, but a few minutes |
| | | after extracting it, it begins to take on a military |
| | | green color, with brown tones. |
| CSH_11 | yes | A bright green color is observed, but a few minutes |
| | | after extracting it, it begins to take on a military |
| | | green color, with brown tones. |
| CSH_13 | yes | A bright green color is observed, but a few minutes |
| | | after extracting it, it begins to take on a military |
| | | green color, with brown tones. |
| LGl_04 | yes | A faint brownish-green color was extracted, which |
| | | remained overnight. |
| LGXi_13 | yes | A brownish-green color was extracted, which |
| | | remained overnight. |
| XXiH_05 | yes | A brilliant translucent green color was extracted, |
| | | remained overnight with no change observed. |
| XXiH_07 | yes | A brilliant translucent green color was extracted, |
| | | remained overnight with no change observed. |
| UGIH_04 | yes | A bright, light green color was extracted, stable |
| | | from one day to the next. |
| UGIH_05 | yes | A bright, light green color was extracted, stable |
| | | from one day to the next. |
| UGIH_13 | yes | A bright, light green color was extracted, stable |
| | | from one day to the next. |
| AT_01 | yes | An olive green color with yellow tones was |
| | | observed, it has remained stable for 4 days |
| UL_01 | yes | An army green color with brown undertones was |
| | | extracted, it stayed the same from one day to the |
| | | next. |
| LGH | yes | A green color was extracted that in minutes turned |
| | | military green with brown tones, remaining the |
| | | same from one day to the next. |
| ML_06 | yes | Extracted an olive green color, clears overnight. |
| AM_03 | yes | Very little color was extracted, almost nothing. It |
| | | is observed that it is translucent yellowish green. |
| AM_09 | yes | Very little color was extracted. It is observed that |
| | | it is a translucent yellowish green color that from |
| | | one day to the next becomes very tenuous. |
| TL_01 | yes | A dark olive green color is extracted. It is stable |
| | | over time. It was possible to verify by means of |
| | | UV that it is chlorophyll B. |
| TL_05 | yes | A dark olive green color is extracted. It is stable |
| | | over time. It was possible to verify by means of |
| | | UV that it is chlorophyll B. |

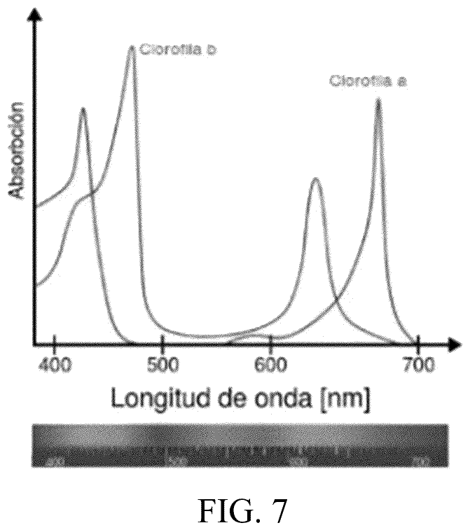

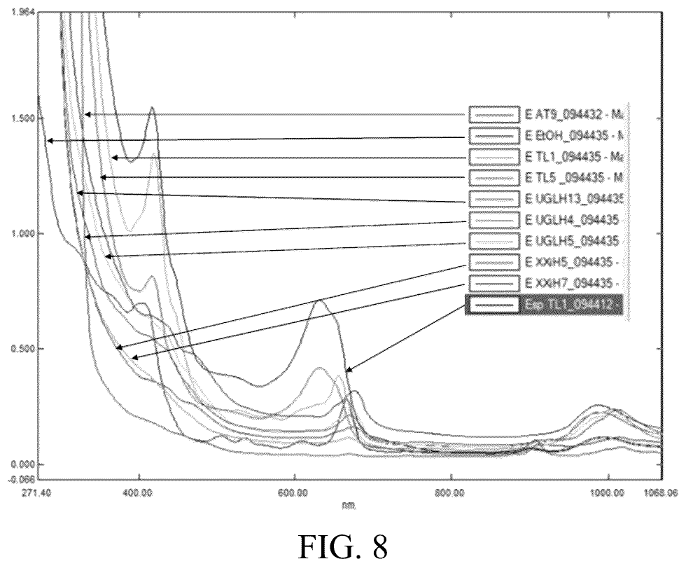

Based on the above table 3 and the qualitative assays for the extraction of chlorophylls from spinach extract, an exhaustive assay using the UV-Vis profile was performed to identify and compare different extractions. The UV-Vis profile of chlorophyll A and B was taken into account as shown in FIG. 7 to study their relative extractions. FIG. 7, which shows the UV Vis spectra of pure chlorophyll A and chlorophyll B was used as the basis upon which it was determined the abilities of the various NADES solvents tested (as shown in FIG. 8) to extract these chlorophylls from the spinach extracts.

FIG. 8 shows the UV-Vis spectrum of some NADES and their ability to extract chlorophylls. It was determined that the TL family of NADES solvents (Thymol: Lactic acid), were the family of solvents that best extracted and stabilized chlorophyll B, relative to extractions performed with ethanol.

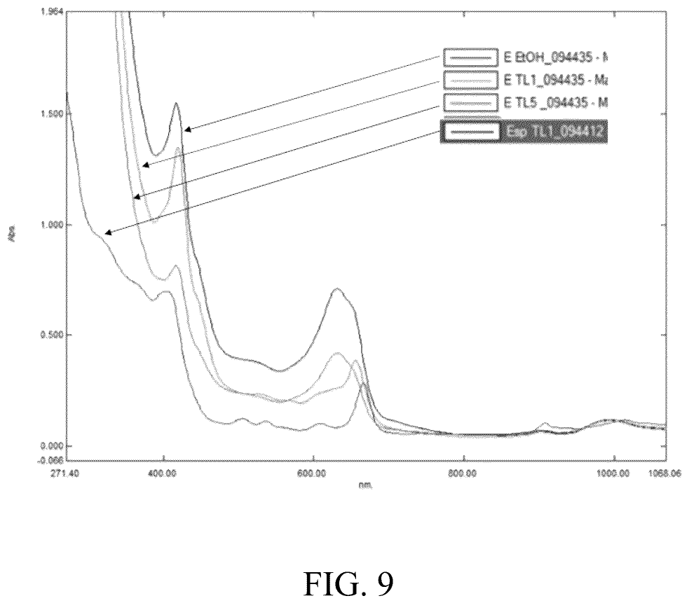

It was determined and is shown in FIG. 9 that all the NADES tested were able to selectively extract chlorophyll B from the spinach extract in higher proportions relative to extractions performed using ethanol, with TL_01 being the solvent that best extracted chlorophylls.

### Extraction Stability of Chlorophyll B

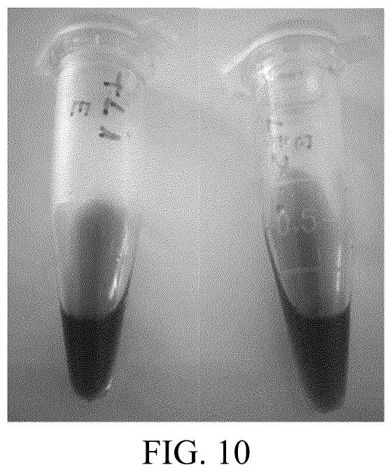

Subsequently, extraction stability was tested. The stability of the spinach extracts in TL_01 was measured on a table at room temperature, where it was observed that it is remarkably stable (less than 5% degradation) over a period of 6 months. The pictures in FIG. 10 shows spinach extracts stored on a counter at room temperature with the left-most picture showing the extract after immediate treatment and the right-most picture showing the extract after 6 months.

Results of the Chlorophyll Extracted from Spinach

Several conclusions can be made from the observed results. The best and appropriate solvent was selected that allows the selective extraction of chlorophyll from spinach, with very high stability compared to aqueous solvents, or from alcohols such as methanol or ethanol (for example). Accordingly, the NADES of the present invention should allow a chlorophyll extract to be stored at room temperature and even protected from light for 6 months (and possibly longer) without appreciable degradation consequences. Based upon the results as seen from FIGS. 7-10 the solvent selected comprised a Thymol: Lactic acid (i.e., TL_01).

Red Dye Extracted from Fungus

The red dye that was tested and is under review is synthesized by a fungus. Currently, the dye is extracted with an organic solvent, and the objective of the experiments performed herein was to improve the extractive efficiency from its matrix using the NADES of the present invention. It was determined that this objective could be and was accomplished with the product TL.

In an embodiment, the present invention relates to observing the chemistry of the dye, by means of the distribution of the dye in the components of the extracting product, and in the product itself. In an embodiment, the present invention relates to identifying and understanding the chemical distribution of molecules in the eutectic system selected as the optimum extracting solvent.

### Laboratory Tests

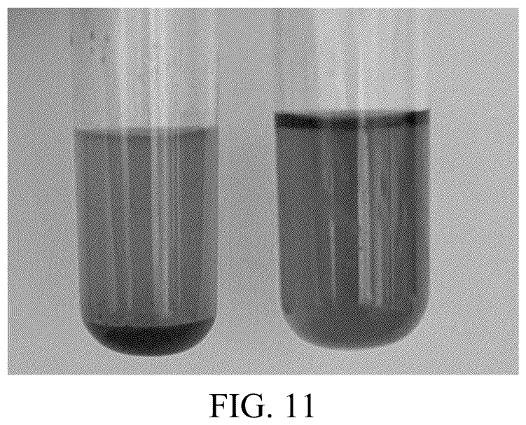

A raw material test was conducted. Initially, in a glass tube comprising 3 mL of thymol (an extract from thyme that is used as an antiseptic) which is a crystalline solid at room temperature and a liquid at 50° C. was added pre-fused to 500 μL of dye (in an aqueous media). The resulting mixture was shaken vigorously using a vortex and centrifuged. It was observed that a dispersion formed and also fast formation of two phases occurred (see FIG. 11, left side).

In the same way, 3 mL (Lactic acid, 85% purity) and 500 μL dye (in an aqueous media) was added and the mix was vortexed. In this case, a homogeneous phase was observed in the analysis media. Thus, it was determined that a mix comprising lactic acid and the red dye formed a homogenous solution (see FIG. 11, right side).

From the results shown in FIG. 11, it can be deduced that in the hydrophobic system provided by the component (see the left side tube), the dye was compatible with the 500 μL of the aqueous media from which it came, remaining pre-concentrated in the shortest phase of the tube (FIG. 11, right image). Moreover, the dye had a homogeneous distribution in the only phase observable, in the hydrophilic system (see FIG. 11 right image)

Test with TL

Further tests were performed on the products selected for this test: TL composed of different ratios of thymol and lactic acid were tested. Significant differences were observed in the composition relative to the raw material of the tests seen in FIG. 11. For this test, 3 mL of each product and 500 μL of dye (aqueous media) were placed in a glass tube, then mixed using a vortex and the mixes were centrifuged at 1000 rpm.

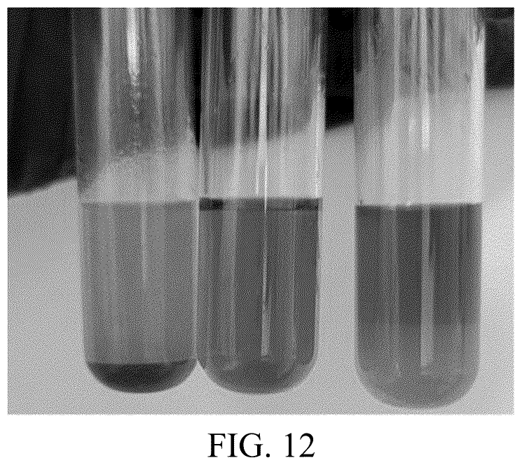

In this case, a cloud-like dispersion of the dye and fast formation of two phases were observed (See FIG. 12, right image). The distribution of the dye in aqueous media revealed the rupture of the eutectic system, and a different intensity of color was observed, but the dye appeared to be homogeneous in both phases. FIG. 12 shows a comparison of the results seen in FIG. 11 showing the hydrophobic component (left most tube) and the hydrophilic component (center tube) to the tube with TL comprising thymol and lactic acid (right most tube).

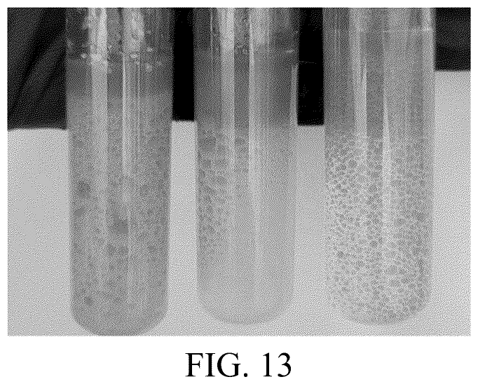

Subsequently, 5 mL of water was added in the systems under study (to the tubes shown in FIG. 12), in order to increase the hydrophilic phase size and those results are shown in FIG. 13. Cloud-like dispersions were observed and flocculation was revealed by phase separation after the addition of the water. This test demonstrated that the eutectic system was broken. The aqueous phase (which is the continuous phase) is the greatest proportion component, and the aqueous phase showed the absence of color. The results demonstrate that the dye changes its preference and its partitioning because the dye appeared in the smallest phase (i.e., in the dispersed phase).

Subsequently, filtration was performed with a 1.2 μm filter and the flocculus could not be retained. The results of this experiment confirm that the dye changed its preference and its partitioning was observed almost exclusively in the smaller hydrophobic phase.

Several conclusions can be deduced from the results of these experiments. First, the dye appears to be compatible with hydrophilic media when only a hydrophilic solvent is used, or with hydrophobic media when only a hydrophobic solvent is used. The eutectic system appears to be the optimal extraction system. However, the addition of water appears to disrupt the eutectic system, and with the help of a dispersing agent the preference of the medium changes, pre-concentrating the dye in the hydrophobic phase of the system.

After the addition of water, it was found that separation of the dye from the supernatant was difficult as the dye starts to crystallize. Because the properties of the red dye in the eutectic solvent system are so unique, it should be appreciated that these unique properties may be capitalized on to provide the ideal situation for extraction of the red dye from the fungus.

Future experiments will evaluate the use of the various extracts in different matrices, including as food additives, as dyes, in medicines, and in other uses in which chlorophyll(s) and lycopene(s) cannabinoid(s), and the red dye is/are or can potentially be used.

In an embodiment, the present invention relates to isolated and/or purified products or natural products derived from various sources by using extraction processes that use NADES. In a variation, the present invention also relates to methods of at least partially isolating and/or purifying products and natural products from sources, the method comprising extracting the product or natural product from one or more sources using NADES, the sources being either natural or man-made. In a variation, the product or natural product may be polyphenols, chlorophyll(s), chlorophyllin(s), lycopene, cannabinoid(s), methylene blue and/or a fungal red dye. In a variation, the NADES can be any of the NADES compositional mixes disclosed herein (in ratios that are also disclosed herein). The source(s) include but are not limited to plants, fungi, or water sources (like waste water). The plants or fungi include but are not limited to spinach, mold, tomato, hemp, alfalfa, grass, and/or nettles.

It should be understood and it is contemplated and within the scope of the present invention that any feature that is enumerated above can be combined with any other feature that is enumerated above as long as those features are not incompatible. Whenever ranges are mentioned, any real number that fits within the range of that range is contemplated as an endpoint to generate subranges. In any event, the invention is defined by the below claims.

We claim:

1. A method of extracting and/or isolating a natural product from a source, said method comprising using a NADES to extract the natural product from the source.

2. The method of claim 1, wherein the natural product comprises polyphenols, chlorophyll(s), chlorophyllin(s), lycopene, cannabinoid(s), and/or a fungal red dye.

3. The method of claim 1, wherein the natural product is one or more chlorophyll(s) or chlorophyllin(s) and the NADES comprises one or more of a) thymol and lactic acid, b) lactic acid, glucose and water, c) citric acid, glycerol and water, d) citric acid, sorbitol, and water, e) lactic acid and glycerol, f) lactic acid, D-glucose, and D-xylose, g) xylitol and D-xylose, h) urea, glycerol and water i) camphor and thymol j) urea and lactic acid, k) lactic acid, glucose, and water l) menthol and lactic acid and/or m) camphor and menthol.

4. The method of claim 1, wherein the natural product is lycopene and the NADES comprises camphor and menthol.

5. The method of claim 1, wherein the natural product comprises cannabinoid(s) and the NADES comprises menthol and oleic acid or menthol and acetic acid.

6. The method of claim 1, wherein the natural product comprises the fungal red dye and the NADES comprises thymol and lactic acid.

7. The method of claim 5, wherein the cannabinoid(s) comprise one or more of CBD, CBDA, CBGA, CBG, THCVA, Δ-9-THC, or THCA.

8. The method of claim 1, wherein the source is a fungus, spinach, Cannabis sativa flowers, or tomatoes.

9. The method of claim 8, wherein the source is spinach.

10. The method of claim 4, wherein the lycophene is derived from a mold or from a tomato.

11. The method of claim 7, wherein the cannabinoid(s) are derived from hemp.

12. The method of claim 2, wherein the chlorophyll(s) or chlorophyllin(s) are derived from one or more of alfalfa, grass and nettles.

13. A method of treating waste water or contaminated water to remove a dye, the method comprising extracting the dye with a NADES.

14. The method of claim 13, wherein the dye is one or more of a red fungal dye or methylene blue.

15. The method of claim 14, wherein the NADES comprises thymol and oleic acid.

16. A method of at least partially isolating and/or purifying a natural product extracted from a source, the method comprising adding a NADES to the source to form a NADES composition, heating the NADES composition to at least 50° C. in a water bath for at least 30 minutes with shaking every 10 minutes for 1 minute, and filtering the NADES composition to generate a mother liquor comprises the natural product and remnants of the source.

17. The method of claim 16, wherein the NADES composition comprises a ratio of the source to the NADES of at least 1% w/w.

18. The method of claim 16, wherein the natural product is one or more of polyphenols, chlorophyll(s), chlorophyllin(s), lycopene, cannabinoid(s), and/or a fungal red dye.

19. The method of claim 18, wherein the natural product comprises chlorophyll(s) or chlorophyllin(s) and the NADES comprises one or more of a) thymol and lactic acid, b) lactic acid, glucose and water, c) citric acid, glycerol and water, d) citric acid, sorbitol, and water, e) lactic acid and glycerol, f) lactic acid, D-glucose, and D-xylose, g) xylitol and D-xylose, h) urea, glycerol and water i) camphor and thymol j) urea and lactic acid, k) lactic acid, glucose, and water l) menthol and lactic acid and/or m) camphor and menthol.

20. The method of claim 18, wherein the one or more of polyphenols, chlorophyll(s), chlorophyllin(s), lycopene, cannabinoid(s), and/or a fungal red dye are derived from spinach, mold, tomato, hemp, alfalfa, grass, and/or nettles.
